(19) United States
(12) Patent Application Publication
(10) Pub. No.: US 2019/0344927 A1
(43) Pub. Date: Nov. 14, 2019

(54) LOCKABLE BOX AND BLANK FOR FORMING THE SAME

(71) Applicant: Huseyin Hayri Kamiloglu, Mersin (TR)

(72) Inventor: FATMA OZGERCEL, Mersin (TR)

(73) Assignee: Huseyin Hayri Kamiloglu, Mersin (TR)

(21) Appl. No.: 16/167,673

(22) Filed: Oct. 23, 2018

(30) Foreign Application Priority Data
May 8, 2018 (TR) 2018/06525

(51) Int. Cl. B65D 5/66; B65D 85/36; B65D 5/42; B65D 5/20; B65D 5/54; B31B 50/26; B31B 50/25; B31B 50/73

(52) U.S. Cl. CPC B65D 5/6655; B65D 85/36; B65D 5/4295; B65D 5/2057; B65D 5/548; B31B 2110/35; B31B 50/25; B31B 50/734; B65D 2585/366; B31B 2241/00; B31B 50/26

(57) ABSTRACT

A lockable box includes a base portion, a lid portion movable into a closed position for closing the base portion, a latching formation formed on one of the lid and base portions and a slit formed on the other of the lid and base portions. The latching formation is receivable within the slit for locking the lid portion in a closed position. The latching formation includes one or more tabs resiliently foldable into a folded position for enabling the latching formation to be received into the slit and for moving out of the folded position for locking the latching formation within the slit once slotted therein.

The present invention concerns a lockable box and preferably a lockable food box, and more preferably a lockable pizza box for pizza and other foods. The present invention further concerns a foldable blank for forming such lockable boxes.

Food containers, such as pizza boxes, are commonly used as boxes for food deliveries. In recent years, food delivery services have become increasingly more popular, as people work longer hours and online ordering platforms have made the ordering, delivery and payment process much more convenient. However, with all food deliveries, there is an ongoing need to ensure that the quality and integrity of the food is maintained between the time it leaves the restaurant and the time at which the customer receives their delivery.

A particular concern is avoiding damage or tampering of the food while it is out on delivery. For example, delivery drivers are sometimes under pressure to complete deliveries within a certain time period (e.g. 30 minutes). However, such targets mean that, in the case of pizza deliveries, if a pizza were to accidentally fall out of its box onto the ground, a delivery driver may decide to put the pizza back into its box and complete the delivery anyway. Equally, a disgruntled delivery driver may decide to tamper with food in their custody as a means of revenge against the restaurant or a particular customer. The above issues are potentially of even greater concern in the scenario where food has been ordered through an online ordering platform because the delivery drivers are typically not employed by the restaurant. As such, the delivery driver may be less invested in ensuring the quality of the food they deliver. There is therefore a need to develop new mechanisms for avoiding damage or tampering to food while it is being delivered; such security mechanisms would not only benefit customers by reassuring them that the integrity of their food has been maintained, but a restaurant would be much less vulnerable to having their reputation compromised by the actions of a rouge delivery person. At the same time, however, the food delivery market remains extremely competitive and any new mechanisms to address the above issues must remain cost effective.

The present invention therefore seeks to address the above.

According to a first aspect of the present invention there is provided a lockable box, comprising: a base portion; a lid portion movable into a closed position for closing the base portion; a latching formation formed on one of the lid and base portions and a slit formed on the other of the lid and base portions, the latching formation being receivable within the slit for locking the lid portion in a closed position; wherein the latching formation comprises one or more tabs resiliently foldable into a folded position for enabling the latching formation to be received into the slit and for moving out of the folded position for locking the latching formation within the slit once slotted therein.

In this way, a lockable container is provided in which, once the lid is closed and the latching formation is slotted into the slit, the tabs are unrestrained within the interior of the box. As such, the resilience of the tabs acts to extend them out from their folded position to catch against the box material surrounding the slit. This locks the lid in a closed position onto the base by coupling the latching formation to the slit. Furthermore, once the latching formation is received within the slit, the tabs are held within the interior of the container, thereby preventing them from being re-folded. This prevents the latching formation from being removed from the slit. Importantly, costs are minimised because the latching mechanism utilises the resilience of the tabs, and therefore no adhesives or additional parts are required to securely close the box. Furthermore, once the container has been closed and locked, the only way to reopen it is by physically damaging the box itself. Therefore, a customer can easily tell if their delivery has been opened because the box will be physically damaged. Conversely, if the box is intact, the customer can be assured that the contents have not been exposed or tampered with since leaving the restaurant.

Preferably, the box further comprises a release formation having perforations for facilitating the tearing of the lid or base portions to release the latching formation. In this way, the physical damage necessary to reopen the box is directed by the perforations along pre-determined fault lines. This allows the customer to neatly open the box by tearing the material along the perforations. At the same time, the security features are maintained since, once torn, the perforations provide a visual indication that the box has been opened.

Preferably, the perforations are provided adjacent to the slit and are tearable for forming an opening encompassing the slit in the respective one of the lid and base portions for releasing the latching formation from the slit. In this way, when torn, the perforations direct the tearing of the box to form a larger aperture where the slit was previously located. As such, this allows the latching formation to be withdrawn from its locked engagement with the box material surrounding the slit.

Preferably, the latching formation is formed on the base portion and the slit is formed on the lid portion. In this way, the latching formation may be provided as a locking flap which extends from the base portion and which can be then folded over the end of the lid portion and fed into the slit formed therein. This thereby forms a secure closure in which the resilience of the box material helps to brace the latching formation into engagement with the material surrounding the slit.

Preferably, the latching formation comprises a flap, and the one or more tabs comprise two tabs laterally projecting from the flap. In this way, a contoured flap arrangement, cut from a sheet of material, can form the locking mechanism.

Preferably, the base portion comprises a base panel and one or more sidewall panels. In this way, the base panel and sidewalls of the base portion define a container region for containing the food.

Preferably, the lid portion comprises a top panel and one or more sidewall flaps connected to the top panel and being foldable downward for receipt into a container region defined by the base panel and one or more sidewall panels when the lid portion is in the closed position. In this way, the sidewall flaps brace against the sidewall panels and prevent lateral movement of the top panel relative to the base panel. At the same time, the sidewall flaps support the top panel above the base panel, thereby defining the top of the container region and forming an interior space for housing food.

Preferably, one of the sidewall panels forms a pivotable connection between the base portion and the lid portion. In this way, the base and lid portions are connected, and the lid may be pivoted between its closed and open positions through this connection.

Preferably, the latching formation projects from a sidewall panel and the slit is formed on the top panel. In this way, when locked, the latching formation extends from a sidewall of the base portion and fits over the edge of the lid, and is retained in the lid's top panel.

Preferably, the box is formed of a foldable sheet material. In this way, the box may be distributed and stored in flat-pack form, and then folded into shape when required.

Preferably, the box is formed from a unitary sheet. In this way, a single sheet of material may be used to form the lockable box, thereby simplifying manufacture and minimising costs. More preferably the box is formed of a unitary sheet of cardboard. Advantageously, cardboard is inexpensive and recyclable.

Preferably, the box is a pizza box. In this way, a lockable pizza box for pizza delivery and takeaway is provided in which the contents of the pizza box is kept secure.

According to a second aspect of the invention, there is provided a blank for a lockable box, comprising a single sheet of foldable material cut and scored to define: a base portion; a lid portion movable into a closed position for closing the base portion; a latching formation formed on one of the lid and base portions and a slit formed on the other of the lid and base portions, the latching formation being receivable within the slit for locking the lid portion in a closed position; wherein the latching formation comprises one or more tabs resiliently foldable into a folded position for enabling the latching formation to be received into the slit and for moving out of the folded position for locking the latching formation within the slit once slotted therein.

In this way, a blank is provided for forming a lockable container. As the latching mechanism utilises the resilience of the tabs, no adhesives or additional parts are required to securely close the box and, once the container has been closed and locked, the only way to reopen it is by physically damaging the box itself. Therefore, the blank provides a box for food deliveries for which the customer can be assured that the box's contents has not been exposed or tampered with since leaving the restaurant.

Preferably, the bank further comprises one or more perforated sections for forming a release formation to facilitate the tearing of the lid or base portions to release the latching formation in use. In this way, the perforations direct the tearing of the box so that when the customer is able to reopen the box neatly.

Preferably, the bank is for a foldable cardboard pizza box. In this way, a lockable pizza box is provided at minimal additional manufacturing cost compared to a conventional pizza box.

Illustrative embodiments of the present invention will now be described with reference to the accompanying drawings in which:

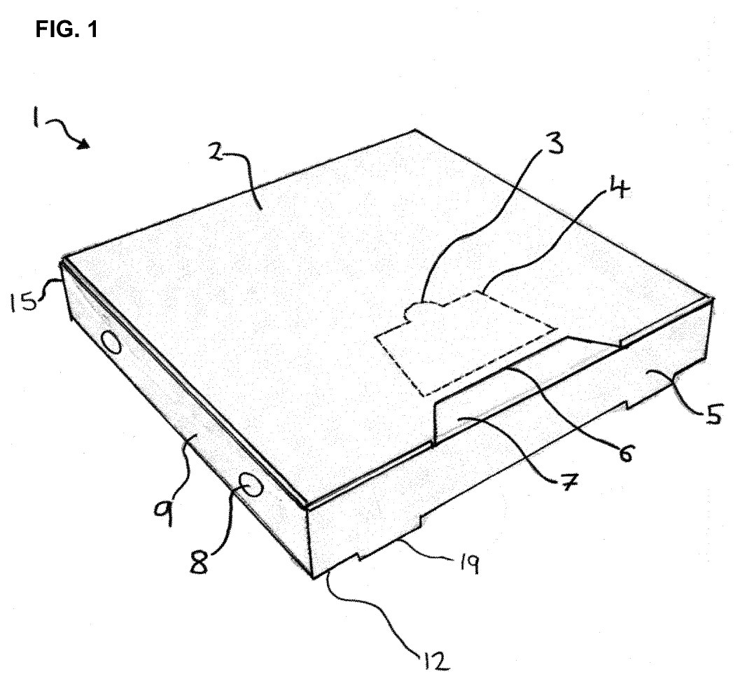

FIG. 1 shows a perspective view of a pizza box according to a first embodiment of the invention, with the lid in a closed position;

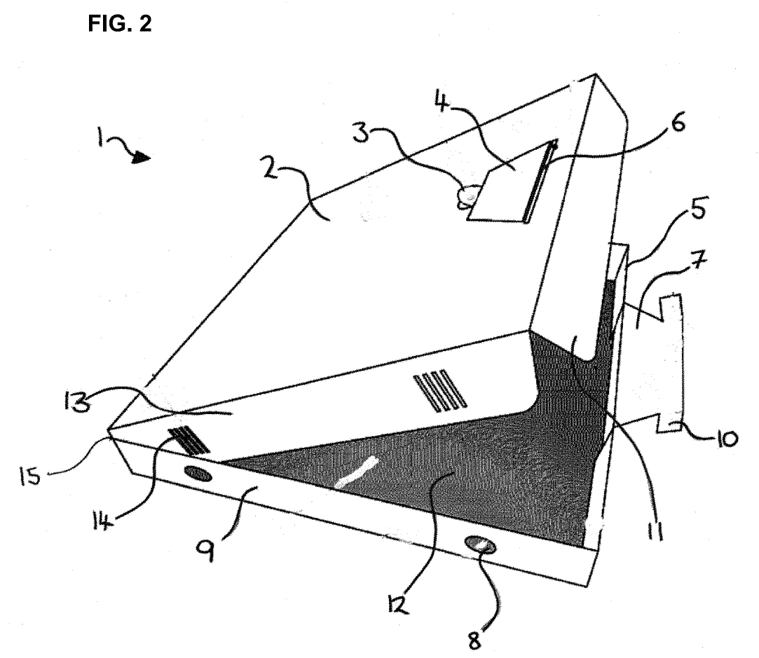

FIG. 2 shows a perspective view of a pizza box of the first embodiment, with the lid in a partially opened position; and

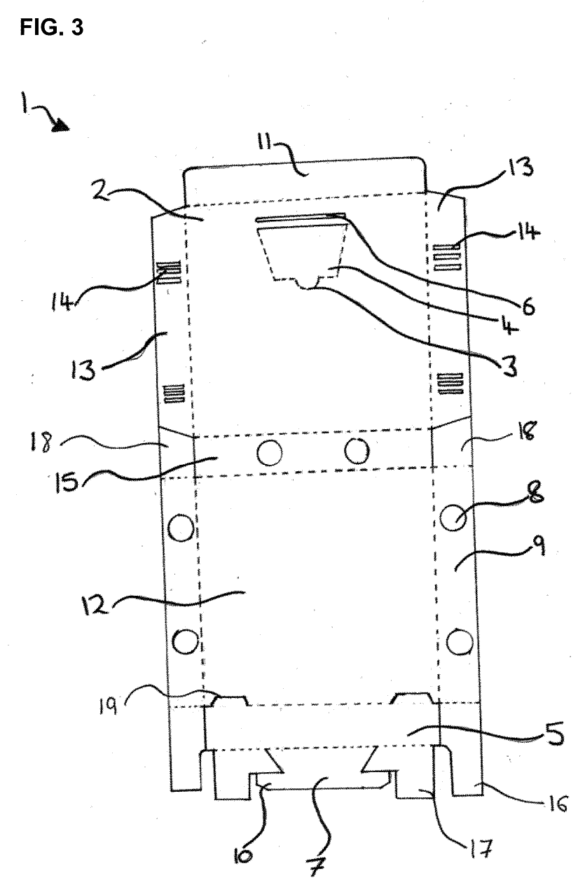

FIG. 3 shows a plan view of the blank for forming the pizza box shown in FIGS. 1 and 2.

FIGS. 1 to 3 show a pizza box 1 according to a first embodiment of the invention. In this embodiment, the box is formed from a single sheet cardboard blank, as shown in FIG. 3.

In FIG. 1, the pizza box 1 is shown with its lid in a closed position over the box's base. The base comprises a bottom base panel 12, with the four sides of the box defined by left and right sidewall panels 9, front sidewall panel 5 and rear sidewall panel 15. When closed, the lid is seated into the space between the sidewall panels, with the lid's top panel 2 covering the container space defined by the base. The left, right and rear side sidewall panels 9,15 are provided with venting holes 8. The front sidewall panel comprises a locking flap 7 which extends from its upper edge. In the closed position, the locking flap 7 extends over the front of the lid's top panel 2 and slots into a slit 6 provided in the top panel 2. The slit 6 provides a thin strip-shaped aperture into the interior of the box into which the distal end of the locking flap 7 is received, as is discussed in further detail below.

Adjacent to the slit 6, there is provided a perforated formation 4, which includes a thumb tab 3. The perforated formation 4 comprises a fault line of weakened material defining a detachable region of the lid's top panel 2. To open the box 1, a user may depress or uplift the thumb tab 3 away from the plane of the lid's top panel 2 and tear along the perforated formation 4 to remove the detachable region from the lid. This tearing action opens an aperture that connects into the slit 6. In this respect, it will be understood that the perforations do not necessarily need to extend to join into the slit 6, and a thin strip of boundary material may be provided between the perforated formation 4 and the slit 6, as shown illustrative embodiment. In this arrangement, as the detachable region is torn away, the thin strip of boundary material is sufficiently weak that it either tears away with the perforated formation 4 or tears as the locking flap 7 is withdrawn.

FIG. 2 shows the pizza box of FIG. 1 with the lid 2 in a opened position. As shown, the top panel 2 has been pivoted back on its connection with rear sidewall panel 15. For illustration, thumb tab 3 is shown partially uplifted. In this view, it can be seen that the lid's top panel 2 supports left and right sidewall flaps 13 and front sidewall flap 11. When the lid is closed, the sidewall flaps 13,11 are folded downwardly to be received within the sidewall panels 9, 5 of the base. In this respect, the left and right sidewall flaps 13 comprise vents 14 which align with venting holes 8 formed in the left and right sidewall panels 9.

FIG. 2 further shows the locking flap 7 when not inserted into the slit 6. As shown, the locking flap 7 is connected to the upper edge of the front sidewall panel 5 and comprises lateral tabs 10 at its distal end, thereby forming a T-shape formation. In this unfolded position, the distal end of locking flap 7 is wider than the slit 6. However, during assembly, the lateral tabs 10 can be folded inward into a folded position, which reduces the width of the distal end of locking flap 7 so that it can be slotted through the slit 6.

FIG. 3 shows a plan view of the blank for forming the pizza box shown in FIGS. 1 and 2. The bank 1 is formed of a single sheet of cardboard and is cut, scored, and perforated to provide the panels when folded. Cuts are shown in solid lines, with scoring and perforations marked with dashed lines.

The lid's top panel 2 is connected to the base panel 12 by rear sidewall panel 15. This forms a hinged connection between the lid and the base. The left and right sidewall panels 9 comprise front corner tabs 16 on their front edges and rear corner tabs 18 on their rear edges.

When the blank shown in FIG. 3 is folded, the sidewall panels 5, 9 are first folded in, so as to be vertical to the base panel 12. The corner tabs 16, 18 are then folded perpendicular to the left and right sidewall panels 9 to define the corners of the box. Corner flaps 17 formed on the front sidewall panel 5 are then folded over the now vertical front corner tabs 16. At the same time, as the front sidewall panel 5 is tilted vertically, feet 19 move with the sidewall panel forming apertures in the base panel 12. These apertures can then receive the ends of the corner flaps 17 once they are folded over, thereby locking the sidewall panels 5, 9 in an upright position relative to the base panel 12, thereby defining the box's interior, as is shown in FIG. 2.

Once food has been placed within the assembled box, the top panel 2 of the lid may then be pivoted over the interior space, with its sidewall flaps 11,13 being positioned downwardly to slide into the interior space, and abut against the sidewall panels. With the lid closed, the locking flap 7 may then be folded over the front end of the top panel 2, and a user can fold in the tabs 10 to reduce the width of the distal end of locking flap 7. This allows the end of the locking flap 7 to be fed through slit 6. Once slotted through the slit 6, the folded tabs 10 project into the interior of the container and hence are no longer restrained by the user or the edges of slit 6 itself. As such, the tabs 10 move outwardly due to the natural resilience of the cardboard sheet. It will be understood that this resilience does not necessarily result in the tabs 10 re-extending fully to their original unfolded position. Nevertheless, the tabs 10 will move partially outward, which has the effect of increasing the footprint of the end of locking flap 7. As the slit 6 is narrow, this expansion of the tabs 10 therefore prevents the end of the locking flap 7 from being withdrawn from the slit 6. That is, the tabs 10 catch the interior surface of the top panel adjacent to the slit 6, and thereby provide a locking engagement that locks the locking flap 7 into the top panel 2, as shown in FIG. 1.

Once assembled in this way, food such as pizza contained within the box is secured. Although the food may be damaged if the box were to be dropped, the locking mechanism prevents the lid from opening, which could otherwise result in the food falling out onto the floor. Equally, this locking also prevents a delivery driver or other third party from opening the box to tamper with the food. That is, as shown in FIG. 1, the tabs 10 are held in the interior of the container and therefore they cannot be accessed to re-fold them to allow the locking flap 7 to be withdrawn from the slit 6. As such, the only way to release the locking flap 7 is to physically damage the box, either by detaching the locking flap 7's connection to the front sidewall 5 or by tearing the box at the locking flap 7's connection to the slit 6. In either case, the damage to the box would be easily identified by the customer and alert them to any potential contamination.

When the customer wishes to open their delivery, they can use a finger to depress thumb tab 3, which causes the perforations to tear, separating the tab away from the top panel 2. Once separated, the customer can hook their finger underneath the perforated region 4 and tear upwardly along the perforated formation 4, thereby removing the detachable region from the lid and opening an aperture encompassing the slit 6. The locking flap 7 may then be withdrawn from this enlarged aperture to release the top panel 2 and allow the container lid to be opened. The customer can then remove their food. Furthermore, because the perforations localise the tearing to a region of the top panel 2 adjacent the slit 6, the lid can be re-closed by the customer. Although in this situation the lid's top panel 2 will have an enlarged aperture, the re-closure of the top panel and sidewall flaps will nevertheless help to keep the food warm during the time period when the customer is consuming the food.

In view of the above, the present invention therefore provides a box for food in which the lid can be locked to the base to secure the container's contents and prevent contamination or tampering. Once the container has been locked, the only way to reopen it is by physically damaging the box itself, which can be easily identified by a customer. Furthermore, as the locking mechanism can be formed by folding a blank having suitable cuts and scoring, no adhesives or additional parts are required. This thereby minimises not only manufacturing costs, but also avoids the costs that would otherwise be associated with additional assembly steps at the restaurant.

It will be understood that the embodiment illustrated above shows applications of the invention only for the purposes of illustration. In practice the invention may be applied to many different configurations, the detailed embodiments being straightforward for those skilled in the art to implement.

In this respect, for example, although embodiments of the present invention may be referred to as a pizza box, it will be understood that pizza boxes may come in different shapes and sizes and may be used for foods other than pizza.

Furthermore, although in the above illustrative embodiment, the locking flap 7 is connected to the front sidewall panel 5, it will be understood that other configurations are possible. For example, in other embodiments, the locking flap 7 could extend from the top panel 2, with the corresponding slit 6 located on the front sidewall panel 5. Equally, although in the illustrative embodiment the perforated formation 4 is provided on the top panel 2, other embodiments are also envisaged, such as having the perforated formation provided on the locking flap itself or at its connection to the front sidewall panel 5. In such embodiments, the distal end of the locking flap 7 would remain locked in the slit 6, but the flap itself would be detached from its connection to the base.

1. A lockable box, comprising:
a base portion;
a lid portion movable into a closed position for closing the base portion;
a latching formation formed on one of the lid and base portions and a slit formed on the other of the lid and base portions, the latching formation being receivable within the slit for locking the lid portion in a closed position;
wherein the latching formation comprises one or more tabs resiliently foldable into a folded position for enabling the latching formation to be received into the slit and for moving out of the folded position for locking the latching formation within the slit once slotted therein.

2. A lockable box according to claim 1, further comprising a release formation comprising perforations for facilitating the tearing of the lid or base portions to release the latching formation.

3. A lockable box according to claim 2, wherein the perforations are provided adjacent to the slit and are tearable for forming an opening encompassing the slit in the respective one of the lid and base portions for releasing the latching formation from the slit.

4. A lockable box according to claim 1, wherein the latching formation is formed on the base portion and the slit is formed on the lid portion.

5. A lockable box according to claim 1, wherein the latching formation comprises a flap, and the one or more tabs comprise two tabs laterally projecting from the flap.

6. A lockable box according to claim 1, wherein the base portion comprises a base panel and one or more sidewall panels.

7. A lockable box according to claim 6, wherein the lid portion comprises a top panel and one or more sidewall flaps connected to the top panel and being foldable downward for receipt into a container region defined by the base panel and one or more sidewall panels when the lid portion is in the closed position.

8. A lockable box according to claim 7, wherein one of the sidewall panels forms a pivotable connection between the base portion and the lid portion.

9. A lockable box according to claim 8, wherein the latching formation projects from a sidewall panel and the slit is formed on the top panel.

10. A lockable box according to claim 1, wherein the box is formed of a foldable sheet material.

11. A lockable box according to claim 10, wherein the box is formed from a unitary sheet.

12. A lockable box according to claim 1, wherein the box is a pizza box.

13. A blank for a lockable box, comprising a single sheet of foldable material cut and scored to define:
a base portion;
a lid portion movable into a closed position for closing the base portion;
a latching formation formed on one of the lid and base portions and a slit formed on the other of the lid and base portions, the latching formation being receivable within the slit for locking the lid portion in a closed position;
wherein the latching formation comprises one or more tabs resiliently foldable into a folded position for enabling the latching formation to be received into the slit and for moving out of the folded position for locking the latching formation within the slit once slotted therein.

14. A blank according to claim 13, further comprising one or more perforated sections for forming a release formation to facilitate the tearing of the lid or base portions to release the latching formation in use.

15. A blank according to claim 14, wherein the bank is for a foldable cardboard pizza box.
